(19) United States
(12) Patent Application Publication
(10) Pub. No.: US 2024/0077455 A1
(43) Pub. Date: Mar. 7, 2024

(54) SMALL-FOOTPRINT ACQUISITION SCHEME FOR ACOUSTIC INSPECTION

(71) Applicant: EVIDENT CANADA, INC., Quebec (CA)

(72) Inventors: André Lamarre, Québec (CA); Guillaume Painchaud-April, L'Ancienne-Lorette (CA); Alain Le Duff, Quebec (CA); Benoit Lepage, L'Ancienne-Lorette (CA)

(21) Appl. No.: 18/547,632

(22) PCT Filed: Feb. 15, 2022
(86) PCT No.: PCT/CA2022/050217

§ 371 Date: Aug. 23, 2023

Related U.S. Application Data
(60) Provisional application No. 63/153,055, filed on Feb. 24, 2021.

(51) Int. Cl. G01N 29/06

(52) U.S. Cl. CPC G01N 29/0645; G01N 2291/044; G01N 2291/106

(57) ABSTRACT

Generally, in a non-destructive test application, a compressed representation of an acoustic echo signal acquired by a non-destructive test (NDT) probe assembly can be received, such as via a network. The compressed representation can include data indicative of changes in phase values of the acoustic echo signal. Using the compressed representation, a time-domain representation of an instantaneous phase signal can be constructed from the compressed representation. The constructed instantaneous phase signal can be used in constructing at least one of an uncompressed acoustic echo signal representation or an image. As an illustration, amplitude values of sampled acoustic echo signals can be suppressed in the compressed representation, reducing data volume associated with transmitting a representation of the acquired acoustic echo signal.

### CLAIM OF PRIORITY

This patent application claims the benefit of priority of Lamarre et al., U.S. Provisional Patent Application Ser. No. 63/153,055, titled “SMALL-FOOTPRINT ACQUISITION SCHEME FOR ACOUSTIC INSPECTION,” filed on Feb. 24, 2021 (Attorney Docket No. 6409.196PRV), which is hereby incorporated by reference herein in its entirety.

### FIELD OF THE DISCLOSURE

This document pertains generally, but not by way of limitation, to non-destructive evaluation, and more particularly, to apparatus and techniques for providing a modularized system topology for performing acoustic inspection, such as to provide processing of acoustic inspection data remotely from a device used for acoustic signal acquisition.

### BACKGROUND

Various inspection techniques can be used to image or otherwise analyze structures without damaging such structures. For example, one or more of x-ray inspection, eddy current inspection, or acoustic (e.g., ultrasonic) inspection can be used to obtain data for imaging of features on or within a test specimen. For example, acoustic imaging can be performed using an array of ultrasound transducer elements, such as to image a region of interest within a test specimen. Different imaging modes can be used to present received acoustic signals that have been scattered or reflected by structures on or within the test specimen.

For example, an amplitude or “A-scan” representation can include generating a plot or other display of a received ultrasound signal magnitude versus time or depth, such as along a linear beam axis or ray traversing the test specimen. Beamforming can be performed using coherent excitation of ultrasound transducers to provide a desired beam angle and focal location. For example, coherent excitation can include applying specified delay values (or phase shift) to pulses for transmission by individual array elements (or apertures defined thereby) to establish one or more desired beam angle and focal location. Alternatively, or in addition, beamforming can be performed in reception such as by summing received acoustic echo signals in manner where signals received from individual array elements are delayed (or phase shifted) to provide one or more of a desired beam angle and focal location.

### SUMMARY OF THE DISCLOSURE

Acoustic testing, such as ultrasound-based inspection, can include focusing or beam-forming techniques to aid in construction of data plots or images representing a region of interest within the test specimen. Use of an array of ultrasound transducer elements can include use of a phased-array beamforming approach and can be referred to as Phased Array Ultrasound Testing (PAUT). For example, a delay-and-sum beamforming technique can be used such as including coherently summing time-domain representations of received acoustic signals from respective transducer elements or apertures. In another approach, a Total Focusing Method (TFM) technique can be used where one or more elements in an array (or apertures defined by such elements) are used to transmit an acoustic pulse and other elements are used to receive scattered or reflected acoustic energy, and a matrix is constructed of time-series (e.g., A-Scan) representations corresponding to a sequence of transmit-receive cycles in which the transmissions are occurring from different elements (or corresponding apertures) in the array. Such a TFM approach where A-scan data is obtained for each element in an array (or each defined aperture) can be referred to as a “full matrix capture” (FMC) technique.

Capturing time-series A-scan data either for PAUT or TFM applications can involve generating considerable volumes of data. For example, digitization of A-scan time-series data can be performed locally by a test instrument having an analog-front-end and analog-to-digital converter physically cabled to a transducer probe assembly. A corresponding digitized amplitude resolution (e.g., 8-bit or 12-bit resolution) and time resolution (e.g., corresponding to a sample rate in excess of tens or hundreds of megasamples per second) can result in gigabits of time-series data for each received A-scan record for later processing as full-bandwidth and full-resolution analytic representations of such signals. Such volumes of data may be cumbersome to transfer between devices or to store. Accordingly, image generation or other analysis would generally be performed locally by the test instrument, and the “full” resolution time-series data would be discarded. Such a volume of data may also practically limit a count of transducer elements or aperture elements used for performing acoustic testing.

To address such technical challenges, the present inventors have recognized, among other things, that an encoding scheme can be used to compress a volume of time-series data acquired from a test probe assembly. For example, a phase-based approach can be used for one or more of acquisition, storage, or subsequent analysis (e.g., A-scan reconstruction or TFM imaging) in support of acoustic inspection. In one approach, a binarization or other quantization technique can be used compress a data volume associated with time-series signal (e.g., A-scan) acquisition. A representation of phase information from the time-series signal can be generated, such as by processing the binarized or otherwise quantized time-series signal. A compressed representation of the time-series can be further manipulated, such as stored or transferred for other analysis.

As an illustration, temporal data indicative of edge transitions within the binarized data can be one or more of stored or transmitted for later use in construction of a time-domain representation of an instantaneous phase signal corresponding to an instantaneous phase of the original time-series A-scan signal. Such temporal data indicative of edge transitions can represent a compressed (e.g., lesser data volume) representation of the acquired time-series data as compared to a full analytic representation. Such reduction in data transfer burden can facilitate a variety of enhancements to acoustic testing protocols and apparatus, such as, for example, facilitating one or more of simplified acoustic transceiver front-end configuration (e.g., relaxing specifications relating to analog-to-digital conversion, particularly amplitude resolution), higher channel counts, faster acquisition, or novel inspection system topologies, as compared to other approaches. As an illustration, if a specified data transfer rate (e.g., “bandwidth”) is available, use of phase-based techniques can allow a higher channel count or acquisition rate (e.g., “frame rate”) for the same bandwidth as compared to a generally-available PAUT or TFM approach involving full analytic signals including amplitude and phase information.

The inventors have also recognized, among other things, that use of a compressed representation of acquired acoustic echo data can facilitate use of a modularized system topology, such as providing for capability of remote (e.g., network-attached compute facility) processing of received acoustic inspection time-series data. Imaging or other analysis data can be transmitted from a compute facility to another client, such as for presentation to a user. In another approach, a probe assembly can include an analog front end (AFE) and transceiver, and another device can receive acoustic echo signal data such as for compression, storage, or image construction. For example, a mobile device, tablet, or other general-purpose device can be used to perform image construction or analysis based on received echo data wireless transferred from an acoustic probe. Other topologies are also possible, such as facilitating remote control or monitoring of acoustic inspection equipment, such as without requiring a physical presence of a human operator.

In an example, such as in a non-destructive test application, a compressed representation of an acoustic echo signal acquired by a non-destructive test (NDT) probe assembly can be received, such as via a network. The compressed representation can include data indicative of changes in phase values of the acoustic echo signal. Using the compressed representation, a time-domain representation of an instantaneous phase signal can be constructed from the compressed representation. The constructed instantaneous phase signal can be used in constructing at least one of an uncompressed acoustic echo signal representation or an image.

As an illustration, amplitude values of sampled acoustic echo signals can be suppressed in the compressed representation, reducing data volume associated with transmitting a representation of the acquired acoustic echo signal as compared to transmitting all amplitude values in an acquired time series. In an example, the acoustic echo signal can be received from a transducer included as a portion of a non-destructive test (NDT) probe assembly, such as where the NDT probe assembly or circuitry coupled thereto forms a discrete-time representation of the acoustic echo signal, encodes the discrete-time representation for transmission, and wirelessly transmits the encoded representation. In an example, establishing the compressed representation comprises binarizing the acoustic echo signal and establishing data indicative of time indices of edge transitions in quantized representations of the received acoustic echo signal. The encoded representation mention above can include the compressed representation (e.g., the NDT probe assembly or circuitry coupled there can provide the binarization and establishing of data indicative of edge transitions).

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising an acoustic inspection system, such as can be used to perform at least a portion one or more techniques as shown and described herein.

FIG. 2 illustrates generally an example comprising an acoustic inspection system, such as having a modular or distributed topology, such as can be used to perform at least a portion of one or more techniques as shown and described herein.

FIG. 3A illustrates generally an example comprising a receiver signal chain such as can be included as a portion of an acoustic inspection system, such as can be used to perform at least a portion of one or more techniques as shown and described herein.

FIG. 3B illustrates generally an example comprising schemes for partitioning a receiver signal chain, such as for providing a modular topology for an acoustic inspection system.

FIG. 3C, FIG. 3D, FIG. 3E, and FIG. 3F illustrate respective examples comprising receiver signal chains having different wireless channel configurations, such as corresponding to the identified locations in FIG. 3B.

FIG. 4A illustrates generally an illustrative example of a “raw” time-series, such as corresponding to an acquired A-scan signal.

FIG. 4B illustrates generally an illustrative example of a normalized time-series and a corresponding binarized representation of the normalized time-series, such as representing an acquitted A-scan signal and a corresponding binarized representation thereof, corresponding to a portion of the time-series shown in FIG. 4A

FIG. 4C illustrates generally an illustrative example of a portion of the normalized time-series of FIG. 4B, a corresponding binarized representation of the normalized time-series of FIG. 4B, and a corresponding instantaneous phase signal.

FIG. 5A, FIG. 5B, and FIG. 5C collectively illustrate generally a first technique that can be used to construct a representation of an instantaneous phase signal (as shown in FIG. 5C) from a binarized representation of an acquired time-series (as shown in FIG. 5A), using data indicative of transitions (e.g., rising edges) in the binarized time-series (as shown in FIG. 5B).

FIG. 5D illustrates generally a comparison between a representation of an instantaneous phase as constructed in FIG. 5C, as compared to the actual acquired instantaneous phase prior to binarization as shown in FIG. 4C.

FIG. 6A, FIG. 6B, and FIG. 6C collectively illustrate generally a second technique that can be used to construct a representation of an instantaneous phase signal (as shown in FIG. 6C) from a binarized representation of an acquired time-series (as shown in FIG. 6A), using data indicative of transitions (e.g., rising and falling edges) in the binarized time-series (as shown in FIG. 6B).

FIG. 6D illustrates generally a comparison between a representation of an instantaneous phase as constructed in FIG. 5C using the first method, a representation of an instantaneous phase as constructed in FIG. 6C using the second method, and the actual acquired instantaneous phase prior to binarization as shown in FIG. 4C.

FIG. 7A illustrates generally an example comprising a portion of a receive signal chain that can be used to provide in-phase and quadrature signals from a phase signal, such as can be used for a phase-summation TFM imaging technique.

FIG. 7B illustrates generally another example comprising a portion of a receive signal chain that can be used to provide in-phase and quadrature signals from a phase signal, including binarization of the in-phase and quadrature representations, such as can be used for a phase-summation TFM imaging technique.

FIG. 8 illustrates generally an illustrative example of in-phase and quadrature signals, such as can be provided using the signal chain shown in FIG. 7A, along with a corresponding binarized representation of an acquired time-series corresponding to an acquired A-scan signal.

FIG. 9 illustrates generally a technique, such as a method for facilitating processing of acoustic echo signals, the technique comprising receiving a compressed representation of an acoustic echo signal and constructing a time-domain representation of an instantaneous phase signal, such as for use constructing a summed A-scan representation or an image, as illustrative examples.

FIG. 10 illustrates generally a technique, such as a method for operating an acoustic inspection system, comprising receiving a command to initiate a non-destructive test operation and to generate a compressed representation of an acoustic echo signal.

FIG. 11 illustrates a block diagram of an example comprising a machine upon which any one or more of the techniques (e.g., methodologies) discussed herein may be performed.

### DETAILED DESCRIPTION

The present subject matter concerns apparatus and techniques that facilitate high-resolution acoustic inspection, such as by enhancing one or more of an element count, a frame rate, a grid resolution, or other parameters relating to processing of acoustic echo signals. For example, A-scan reconstruction or Total Focusing Method techniques can be performed using a phase-based approach as shown and described herein. Such an approach enables encoding of phase information in a compressed manner. Such encoding can be used to provide a small-footprint modularized probe assembly, where small-footprint refers to the probe not requiring an on-board or nearby processing facility to perform imaging computation. The techniques for encoding shown and described herein also facilitate transmission, storage, and remote processing of time-series acoustic echo signal data by dramatically reducing a data volume associated with individual echo signals. Use of the techniques described herein enable novel inspection system topologies, such as modularized where a probe assembly is wireless communicatively coupled with other devices such as one or more of a network-accessible compute facility or nearby mobile device.

Generally, capturing time-series A-scan data for PAUT or TFM applications can involve generating considerable volumes of data. A phase-based approach can be used for one or more of acquisition, storage, or subsequent analysis (e.g., A-scan reconstruction or imaging) in support of acoustic inspection. Use of a phase-based approach can address other technical challenges as well. For example, a challenge can exist because pulse echo amplitude data obtained from an ultrasound transducer array can be affected by various factors, such as one or more of diffraction effects (from transmitter element, receiver element, or scatterers), transmission/reflection at interfaces having differing constitutive characteristics, geometric attenuation of signals, and absorption or frictional losses, as illustrative examples. The factors mentioned above affect amplitude and are generally compensated by empirical measurements (e.g., using Time Correction Gain (TCG) and Angle Correction Gain (ACG), for example). Accordingly, if an analytical notation is used to refer to the received signal summation, the compensations mentioned above (TCG and ACG) affect the individual element amplitude terms (“a_{qp}(r)”), for a Q×P element array, where q and p represent element indices:

A(r)=Σ_{qp}^{QP}a_{qp}(r)e^{iθ}^{_{qp}}^{(r)} (EQN. 1)

In EQN. 1, A(r) represents a pixel or voxel value for a spatial location described by the vector, “r”, and a_{qp} represents an amplitude component for a corresponding transmit-receive pair at element indices q and p. Accordingly, to remedy such challenges, such amplitude terms can be factored out of the summation process, leaving the phase-related coherence terms to be summed (“e^{iθ}^{_{qp}}^{(r)}”):

\tilde{A}(r)=Σ_{qp}^{QP}e^{iθ}^{_{qp}}^{(r)} (EQN. 2)

By use of such factorization, factors influencing amplitude are suppressed (because such factors may influence terms that have now been moved “outside” the summation), while the phase-related terms (e.g., associated with scatterers or other features of interest) remain. As mentioned elsewhere herein, individual time-domain representations of instantaneous phase signals can be acquired, compressed, and reconstructed. Acquisition can be performed using a front-end configuration having a reduced dynamic range as compared to existing approaches that use amplitude and phase information. A compressed representation of the instantaneous received phase signals allows efficient transfer of acquired time-domain data between devices or functional blocks within a testing or imaging system, including wired or wireless transmission of such data to other devices for further analysis, processing, or storage. Re-construction of representations of instantaneous phase signals corresponding to acquired echo signals facilitates A-scan reconstruction or imaging (e.g., TFM imaging).

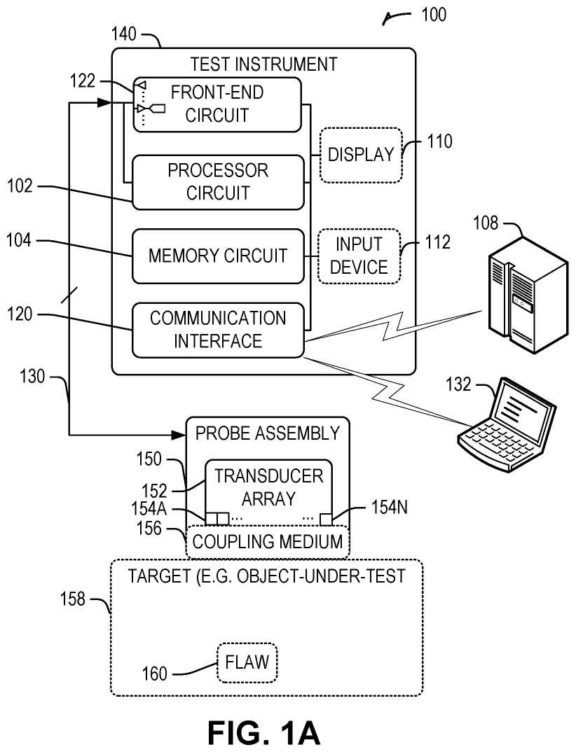

FIG. 1 illustrates generally an example comprising an acoustic inspection system 100, such as can be used to perform at least a portion one or more techniques as shown and described herein. The inspection system 100 can include a test instrument 140, such as a hand-held or portable assembly. The test instrument 140 can be electrically coupled to a probe assembly, such as using a multi-conductor interconnect 130. The probe assembly 150 can include one or more electroacoustic transducers, such as a transducer array 152 including respective transducers 154A through 154N. The transducers array can follow a linear or curved contour or can include an array of elements extending in two axes, such as providing a matrix of transducer elements. The elements need not be square in footprint or arranged along a straight-line axis. Element size and pitch can be varied according to the inspection application.

A modular probe assembly 150 configuration can be used, such as to allow a test instrument 140 to be used with various different probe assemblies 150. Generally, the transducer array 152 includes piezoelectric transducers, such as can be acoustically coupled to a target 158 (e.g., a test specimen or “object-under-test”) through a coupling medium 156. The coupling medium can include a fluid or gel or a solid membrane (e.g., an elastomer or other polymer material), or a combination of fluid, gel, or solid structures. For example, an acoustic transducer assembly can include a transducer array coupled to a wedge structure comprising a rigid thermoset polymer having known acoustic propagation characteristics (for example, Rexolite® available from C-Lec Plastics Inc.), and water can be injected between the wedge and the structure under test as a coupling medium 156 during testing.

The test instrument 140 can include digital and analog circuitry, such as a front-end-circuit 122 including one or more transmit signal chains, receive signal chains, or switching circuitry (e.g., transmit/receive switching circuitry). The transmit signal chain can include amplifier and filter circuitry, such as to provide transmit pulses for delivery through an interconnect 130 to a probe assembly 150 for insonification of the target 158, such as to image or otherwise detect a flaw 160 on or within the target 158 structure by receiving scattered or reflected acoustic energy elicited in response to the insonification.

While FIG. 1 shows a single probe assembly 150 and a single transducer array 152, other configurations can be used, such as multiple probe assemblies connected to a single test instrument 140, or multiple transducer arrays 152 used with a single or multiple probe assemblies 150 for tandem inspection. Similarly, a test protocol can be performed using coordination between multiple test instruments 140, such as in response to an overall test scheme established from a master test instrument 140, or established by another remote system such as a compute facility 108 or general purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples.

The receive signal chain of the front-end circuit 122 can include one or more filters or amplifier circuits, along with an analog-to-digital conversion facility, such as to digitize echo signals received using the probe assembly 150. Digitization can be performed coherently, such as to provide multiple channels of digitized data aligned or referenced to each other in time or phase. The front-end circuit can be coupled to and controlled by one or more processor circuits, such as a processor circuit 102 included as a portion of the test instrument 140. The processor circuit can be coupled to a memory circuit, such as to execute instructions that cause the test instrument 140 to perform one or more of acoustic transmission, acoustic acquisition, processing, or storage of data relating to an acoustic inspection, or to otherwise perform techniques as shown and described herein. The test instrument 140 can be communicatively coupled to other portions of the system 100, such as using a wired or wireless communication interface 120.

For example, performance of one or more techniques as shown and described herein can be accomplished on-board the test instrument 140 or using other processing or storage facilities such as using a compute facility 108 or a general-purpose computing device such as a laptop 132, tablet, smart-phone, desktop computer, or the like. For example, processing tasks that would be undesirably slow if performed on-board the test instrument 140 or beyond the capabilities of the test instrument 140 can be performed remotely (e.g., on a separate system), such as in response to a request from the test instrument 140. Similarly, storage of imaging data or intermediate data such as A-scan matrices of time-series data or compressed phase data, for example, can be accomplished using remote facilities communicatively coupled to the test instrument 140. The test instrument can include a display 110, such as for presentation of configuration information or results, and an input device 112 such as including one or more of a keyboard, trackball, function keys or soft keys, mouse-interface, touch-screen, stylus, or the like, for receiving operator commands, configuration information, or responses to queries.

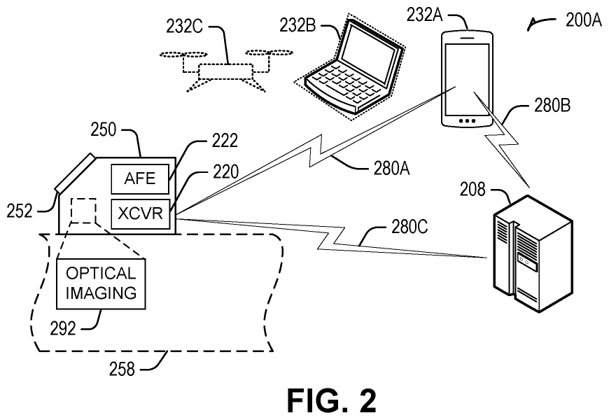

FIG. 2 illustrates generally an example comprising an acoustic inspection system 200A, such as having a modular or distributed topology, such as can be used to perform at least a portion of one or more techniques as shown and described herein. In the system 200A of FIG. 2, a non-destructive test (NDT) probe assembly 250 can include circuitry to receive acoustic echo signals, such as from an array 252 of electroacoustic transducers, such as shown and described in relation to the system 100 of FIG. 1. In the example of FIG. 2, the probe assembly 250 can include or can be conductively coupled with an analog front-end circuit (AFE) 222. The AFE 222 can be used to process received electrical signals representative of acoustic echoes detected by the array 252. Other circuitry, such as acoustic transmit drive circuitry can be used to excite the array to generate acoustic pulses to be received by the array 252 and processed by the AFE 222. The AFE can be communicatively coupled to a wireless transceiver circuit (abbreviated as XCVR) 220, such as to wirelessly transmit an encoded or compressed representation of a received acoustic echo signal to another device. For example, the transceiver circuit could include a cellular radio or satellite radio communication system, or in general, a wide-area network (WAN) digital radio. For example, the probe assembly 250 could include one or more transceiver circuits to facilitate communication via a network with a network-accessible compute facility 208, via a communicative coupling 280C (e.g., a wireless link).

While the communicative coupling 280C is shown as leading directly from the probe assembly 250 to the compute facility 208, any number of intermediate devices could be used to facilitate such communication, such as including one or more of a base station or wirelessly-accessible network gateway, a repeater device such as an on-site repeater or gateway device, or other devices such as a drone 232C, aerostat, satellite, laptop 232B, or mobile device 232A. Wide-area protocols use for communication between the probe assembly 250 and remote resources such as compute facility 208 can include one or more of a Message Queue Telemetry Transport (MQTT) scheme, a Constrained Application Protocol (CoAP) scheme, or use of cellular communications or satellite communications infrastructure. Such communications schemes could be used for communication from an intermediary device such as a mobile device 232A, to a compute facility 208 via a communicative coupling 280B. In an illustrative example, an intermediary device such as a mobile device 232A or laptop 232B can include a first transceiver circuit using a relatively-shorter range communication scheme via a first communicative coupling 280A, and a second transceiver circuit using a relatively longer-range communication scheme (such as conforming to a wide-area protocol) for a second communicative coupling 280B. Such an approach can be referred to as a “two-hop” scheme. In illustrative (but non-limiting) examples where the communicative coupling 280A is a relatively-shorter range communication scheme, the communicative coupling 280A can include use of one or more of a wireless networking scheme (such as conforming to one or more IEEE 802.11-family standards such as implementing a WiFi® scheme), or using another scheme such as Blueooth®, Bluetooth® Low Energy (BLE), an 802.15 wireless personal-area-network standard such as ZigBee or a visible light communication scheme, for example.

One or more of the devices that can be included or accessed by the system 200A can be used to initiate, control, monitor, trigger, or terminate a non-destructive test to be performed by the probe assembly 250 to inspect a target 258. For example, the probe assembly 250 can be fixed, manually positionable, or automatically positionable (e.g., motorized or actuated) to perform a specified test protocol. Unlike other approaches, the phase-based techniques shown and described herein facilitate use of a modularized topology where the probe assembly 250 need not be in wired communication with other control or processing devices. The probe assembly 250 can include or can be coupled with a power source or other circuitry (such as a microcontroller or microprocessor) to perform control of one or more of acoustic transmission or acoustic reception circuitry, without requiring a capability to perform intensive signal processing such as A-scan reconstruction or TFM imaging on-board the probe assembly 250. Such an approach can be referred to as a “small footprint” probe assembly 250, where “small footprint” generally refers to a reduced complexity of on-board signal processing included at the probe assembly 250 or at the point-of-use where the probe assembly 250 is used to perform inspection.

As discussed elsewhere herein, various receiver topologies can be used for the AFE 222 and related circuitry and use of a binarization approach and related phase-encoding can simplify the AFE configuration. Such a receive scheme can also facilitate use of a modified transmit scheme. For example, a transmit pulse amplitude can be reduced compared to other approaches because a dynamic range associated with use of a single-bit quantizing receive approach can be lessened as compared to a corresponding high-resolution amplitude sampling using multi-bit analog-to-digital conversion. Use of a lower transmit amplitude can facilitate higher channel counts and more compact transmit circuitry or transducer geometry, as illustrative enhancements as compared to generally-available approaches involving summed A-scan or TFM imaging where the phase-encoding scheme is not used.

Use of a small-footprint or remotely-controlled probe assembly 250 enables remote inspection schemes or other use cases where the probe assembly 250 is not connected to other portions of the system 200A via a wired link. For example, in locations that are difficult to access by inspection personnel or remote (such as pipeline or off-shore inspection scenarios), the probe assembly 250 can be controlled via a wireless link (e.g., a communicative coupling 280A or 280C), and can provide acoustic inspection data in a compressed manner. Other data can be provided, such as environmental data or test configuration information. In an example, the probe assembly 250 can include optical imaging 292 capability, such as one or more digital imaging sensors. Such optical imaging can include visible light imaging or infra-red imaging, for example. Such optical imaging can be obtained before, after, or contemporaneously with acoustic inspection performed by the probe assembly 250, and such imaging data can be provided to an intermediary device such as the drone 232C, laptop 232B, or mobile device 232A, or to another repository, such as provided by a cloud compute facility 208.

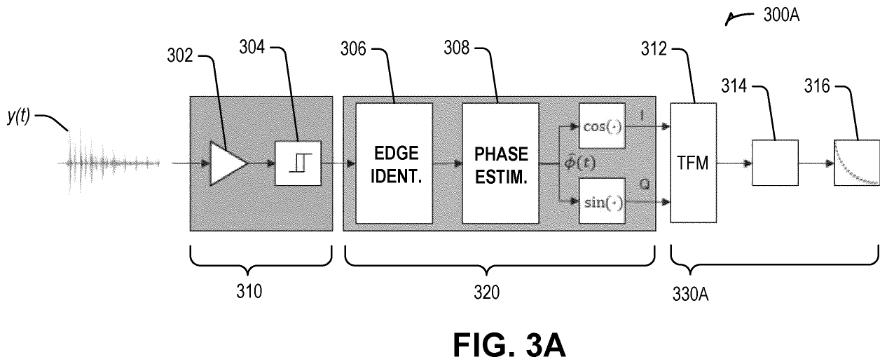

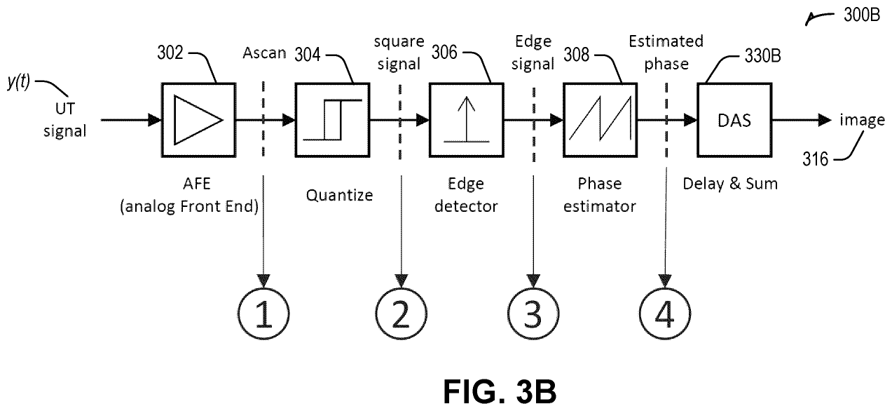

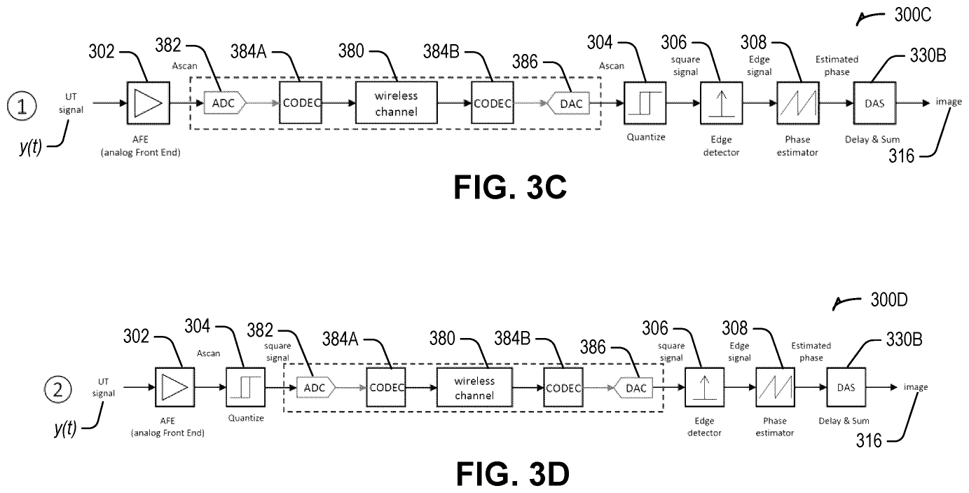

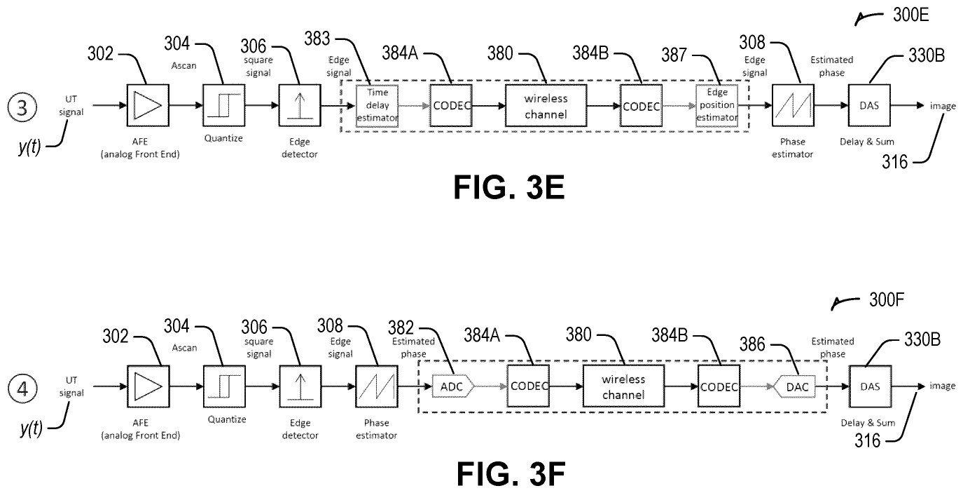

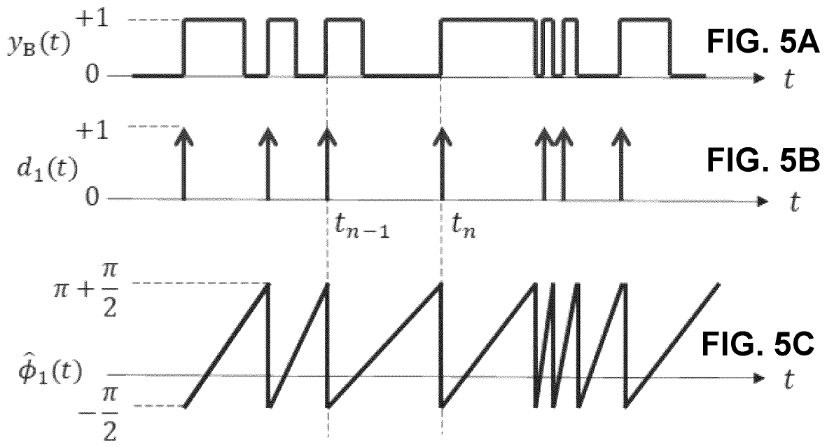

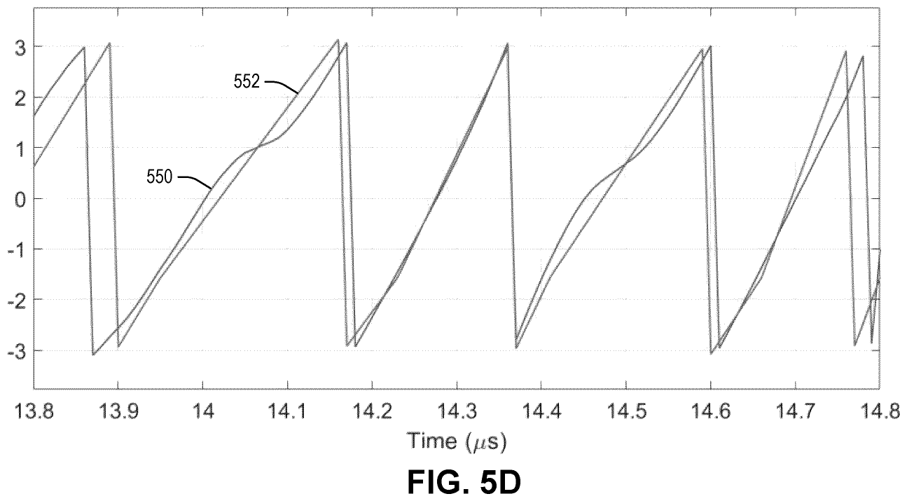

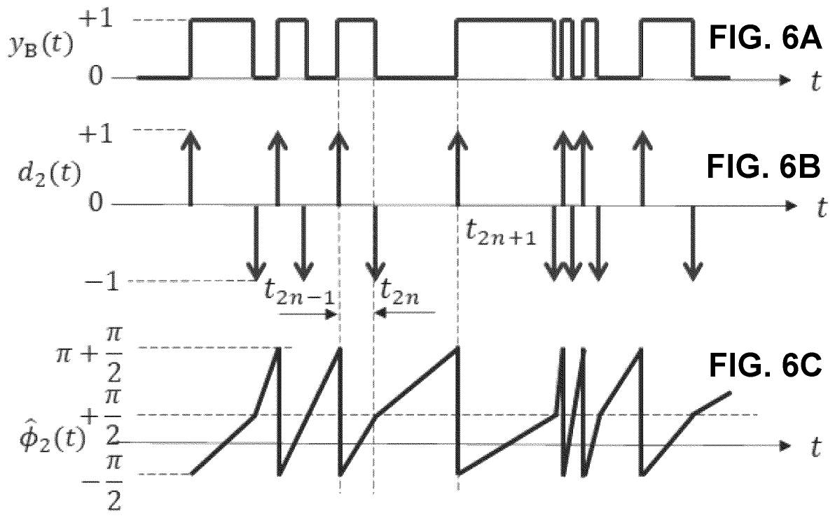

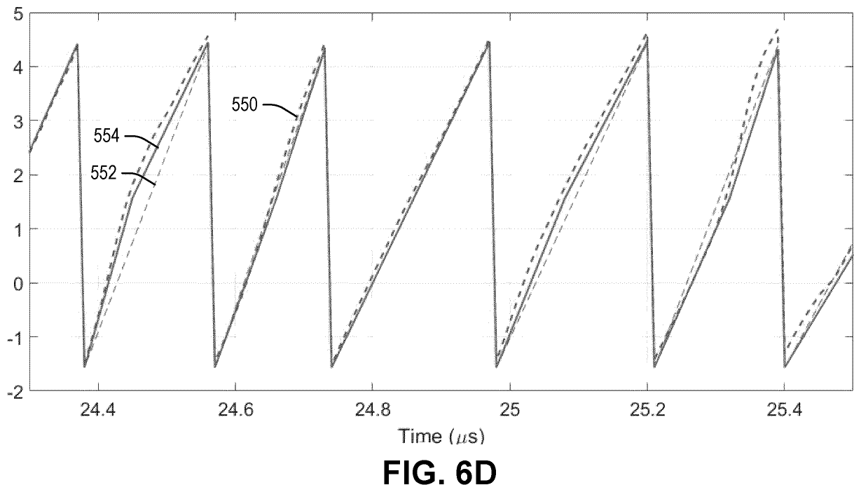

FIG. 3A illustrates generally an example comprising a receiver signal chain 300A such as can be included as a portion of an acoustic inspection system 100, such as can be used to perform at least a portion of one or more techniques as shown and described herein. The signal chains of the examples of FIG. 3A through FIG. 3F can be used to perform a phase-summation imaging technique, such as shown and described according to various examples in this document. Referring to FIG. 3A, a time-domain pulse echo y(t) can be received, such as received by a transducer in an acoustic transducer array used for PAUT or TFM imaging. An amplifier or other circuitry comprising an analog front end circuit 302 can be included as a portion of an analog input block 310. The amplifier can be coupled to an analog-to-digital converter. For example, for single-bit (i.e. “1-bit”) quantizing or “binarization” of the received pulse echo signal, “y(t),” a comparator circuit 304 can be used. A digital representation of the pulse echo signal can be provided to a digital block 320 of the receive signal chain 300, such as to perform edge identification at 306 (e.g., to identify temporal locations of edge transitions in the digital representation of the pulse echo signal. At 308, a phase estimation approach can be implemented, such as corresponding to the first or second techniques described herein at FIG. 5A, FIG. 5B. and FIG. 5C or FIG. 6A, FIG. 6B, or FIG. 6C, for example. A resulting estimate (e.g., “reconstruction”) of the instantaneous phase signal, \hat{ϕ}(t), can be processed, such as by a Hilbert transform or other technique to provide in-phase , “I,” and quadrature, “Q” time-domain signals. The time-domain signals, generated from the estimated instantaneous phase signal can be used to perform imaging via TFM at 312, in a manner similar to generally-available TFM imaging, but without requiring the full A-scan amplitude data from the original acquired pulse echo signals such as represented by a group of signals similar to y(t) (e.g., the elementary A-scan pulse echo signals). At 314, further processing of the TFM image can be implemented, such as to perform one or more of gamma correction or spatial filtering, or to perform application of another convolution mask, to produce a TFM image at 316 based on the phase-summation technique.

The analog input block 310 of FIG. 3A can be replicated, such as to provide multiple channels corresponding to a count of elements in the transducer array, or the analog input block 310 can be shared or multiplexed for acquisition of pulse echo signals from multiple transducer elements, such as in a time-interleaved manner. As an illustrative example, the analog input block 310 can include a low noise amplifier with a 37 decibel (dB) (+74x) gain, such as using an LT1806 integrated circuit available from Analog Devices (Woburn, MA), which can provide a 325 MHz gain-bandwidth product, a 140 Volt-per-microsecond slew rate and a 85 milliamp output current. Binarization can be performed such as using an LT1719 integrated comparator circuit, also available from Analog Devices (Woburn, MA). The comparator circuit 304 can provide hysteresis, such as to suppress unwanted output transitions due to noise. The analog input block 310 or portions of the analog input block 310 can include a standby or shutdown capability, such as to enter a near-zero or zero current consumption mode when not being used for acquisition. In this manner, a portable or hand-held inspection instrument housing the analog input block 310 can be powered by batteries and can conserve operating energy to extend operating life between recharges or can support higher channel counts for the same battery longevity as compared to other approaches, as illustrative examples.

A portion or an entirety of processing performed in the digital block 320 need not be performed on the same physical device or instrument as is used for acquisition. For example, after binarization by the comparator circuit 304, a representation of the binarized pulse echo signal can be transmitted to another device or assembly for downstream processing. Similarly, an output from the edge identification at 306 can be referred to as a “compressed” representation of the phase data corresponding to the binarized pulse echo signal. The compressed representation can be transmitted to another device or assembly for downstream processing.

FIG. 3B illustrates generally an example comprising schemes for partitioning a receiver signal chain 300B, such as for providing a modular topology for an acoustic inspection system. Generally, as discussed in relation to examples elsewhere herein such as the system 200A of FIG. 2, partitioning of the receiver signal chain 300B can facilitate one or more of simplification of the probe assembly, such as reducing an overall data-transfer burden, or enhanced channel count using existing data-transfer facilities (e.g., compression of data using a phase-based acquisition approach allows greater channel count for the same or reduced data transfer bandwidth). As shown in FIG. 3B, there are many different approaches that can be used to “partition” the receive channel between the probe assembly processing circuitry and other circuitry, such as located on-board an intermediary device or provided by a remote compute facility. Generally, as discussed above in relation to FIG. 3A, a received signal from an ultrasound transducer (UT), y(t), can be filtered or amplified, such as by an analog front-end circuit (AFE) 302. An output of the AFE 302 could be transmitted wirelessly (e.g., as an analog representation or digitized as shown in scheme (1), discussed below in FIG. 3C). A representation of the signal y(t) can be quantized (e.g., “binarized” as shown and described elsewhere herein) by a quantizer circuit (e.g., a comparator 304 or analog-to-digital converter) to provide a discrete-amplitude or “square” signal.

This representation could be wirelessly transmitted as shown in scheme (2), discussed below in FIG. 3D. An edge detector 306 or other circuitry can be used such as to provide time indices indicative of at least of rising edges or falling edges in the discrete-amplitude signal provided by the quantizer (e.g., comparator 304). This is yet another location where data indicative of the time indices of rising or falling edges could be transmitted wirelessly as shown in scheme (3), discussed below in FIG. 3E. A phase estimator 308 can be used to construct an estimate of a time-domain phase of the UT signal y(t) (e.g., to perform phase reconstruction). A representation of the estimated phase could be transmitted wirelessly as shown in scheme (4), discussed below in FIG. 3F. At 330B, a delay-and-sum approach or other processing could be performed on the estimated phase signal, such as to perform TFM imaging or to reconstruct an A-scan representation, and at 316 an image can be generated. As discussed in relation to the examples below, downstream processing after any of schemes (1), (2), (3), or (4) could be performed at least in part using one or more of an intermediary device or a remote compute facility, such as to facilitate use of a small-footprint wirelessly-controlled acoustic probe assembly.

FIG. 3C, FIG. 3D, FIG. 3E, and FIG. 3F illustrate respective examples comprising receiver signal chains having different wireless channel configurations, such as corresponding to the identified locations in FIG. 3B. In FIG. 3C, corresponding to scheme (1) mentioned above, a receive signal chain 300C receives the UT signal, y(t), and provides an output of the AFE to an analog-to-digital converter 382. Optionally, an encoder 384A implementing a specified CODEC is used to provide an encoded representation of the digitized UT signal over a wireless channel 380. Accordingly, AFE circuit 302, ADC 382, and the encoder 384A are included as a portion of an ultrasound probe assembly, and other downstream elements may be located elsewhere. A decoder 384B implements a complementary CODEC to decode the wirelessly-transmitted representation of the acoustic echo signal, y(t). Optionally, a digital-to-analog converter 386 can be used to provide an analog representation of the received signal, or the wireless channel could operate using a transmitted and received analog representation. A quantizing circuit 304 (operating either on an analog or digital representation of the received signal) can quantize the signal as discussed above in relation to the examples of FIG. 3A or FIG. 3B, with further detection of time indices of edges in the quantized signal by the detector 306 and estimation of the phase by a phase estimator 308 for use in a delay-and-sum determination at 330B, such as to provide an image 316.

FIG. 3D illustrates another example comprising a receiver signal chain 300D corresponding to scheme (2) mentioned above. By contrast with FIG. 3C, in FIG. 3D, the acoustic echo signal from the ultrasound transducer, y(t), can be processed with the AFE circuit 302 then quantized by a quantizer circuit (e.g., a comparator 304 or 1-bit A-to-D converter). An ADC 382 can be used if the quantizer circuit provides an analog output, then other downstream processing is similar to FIG. 3C except that the quantizing by the quantizer circuit is performed prior to wireless transfer. As shown in FIG. 3D, decoding at 384B, and construction of an estimated phase signal are performed using a received representation of the quantized signal from the quantizer circuit. This may involve considerably less data being transferred across the wireless channel 380 even if the sample rate used in FIG. 3D is the same as is used by the ADC 382 in FIG. 3C, because the quantized representation might include as few as a single-bit representation (e.g., binarized representation) having only two possible states. As discussed elsewhere herein, use of a phase base approach allows TFM imaging or A-scan reconstruction despite the significant amplitude quantization error associated with single-bit digitization because such techniques do not require highly-accurate amplitude data but instead use instantaneous phase values reconstructed from, for example, edges detected in a binarized waveform.

FIG. 3E illustrates yet another example comprising a receiver signal chain 300E corresponding to scheme (3) mentioned above. In FIG. 3E, even greater savings in data transmission bandwidth across the wireless channel 380 can be achieved as compared to FIG. 3C or FIG. 3D, because the AFE circuit 302, quantizer (e.g., comparator circuit 304 or other quantizer), and edge detector 306 are ahead of the wireless channel 380. For example, edge locations identified by the edge detector 306 can be translated into time-delay values (e.g., time indices corresponding to either rising or falling edge locations) by an estimator circuit 383, and an encoded representation of such values can be provided at 384A. The edge positions can be decoded and extracted at 384B and 387, respectively, and a phase estimator 308 can be used to reconstruct an instantaneous phase signal corresponding to the acoustic echo signal, y(t) as in other examples, such as to provide a reconstructed A-scan representation or image at 316 via a delay-and-sum approach at 330B (or another approach).

FIG. 3F illustrates yet another example comprising a receiver signal chain 300F corresponding to scheme (4) mentioned above. In FIG. 3F, processing of the acoustic echo signal, y(t), includes an AFE circuit 302, a quantization circuit 304, an edge detector 306, and a phase estimator 308. The estimated phase is transmitted over the wireless channel 380, such as digitized by an analog-to-digital converter 382 and encoded using a CODEC 384A, then decoded upon receipt at CODEC 384B. In the examples above of FIG. 3B, FIG. 3C, FIG. 3D, FIG. 3E, and FIG. 3F, the use of the phrase “CODEC” does not require that blocks labeled “CODEC” perform both coding and decoding. For example, CODEC 384A can be used for encoding, and CODEC 384B can be used for decoding data transmitted over a wireless channel that was encoded using CODEC 384A.

The receiver topologies discussed above can also be used to process acoustic echo signals elicited by a modified transmit scheme, as compared to generally-available transmit approaches. For example, a transmit pulse amplitude can be reduced compared to other approaches. A dynamic range associated with use of a single-bit quantizing receive scheme (see FIG. 3C, for example) can be lessened as compared to a corresponding high-resolution amplitude sampling using multi-bit analog-to-digital conversion. Use of a lower transmit amplitude can facilitate higher channel counts and more compact transmit circuitry or transducer geometry, as illustrative enhancements as compared to generally-available approaches involving summed A-scan or TFM imaging where phase summation is not used.

$${y}_{B} ( t ) = 1 when y ( t ) > 0 and {y}_{B} ( t ) = 0 when y ( t ) < 0 \\ {y}_{B} ( t ) = \frac{1}{2} \cdot \{ 1 + sign [ y ( t ) ] \}$$

For y(t) values of exactly zero, the result can be assigned as zero, as an example, or as one, as another example. The amplitude of the binarized representation is normalized to values of zero or one, but could be scaled appropriately, gated, or otherwise conditioned to provide a voltage mode or current mode digital signal having desired logic-high and logic-low levels for downstream processing.

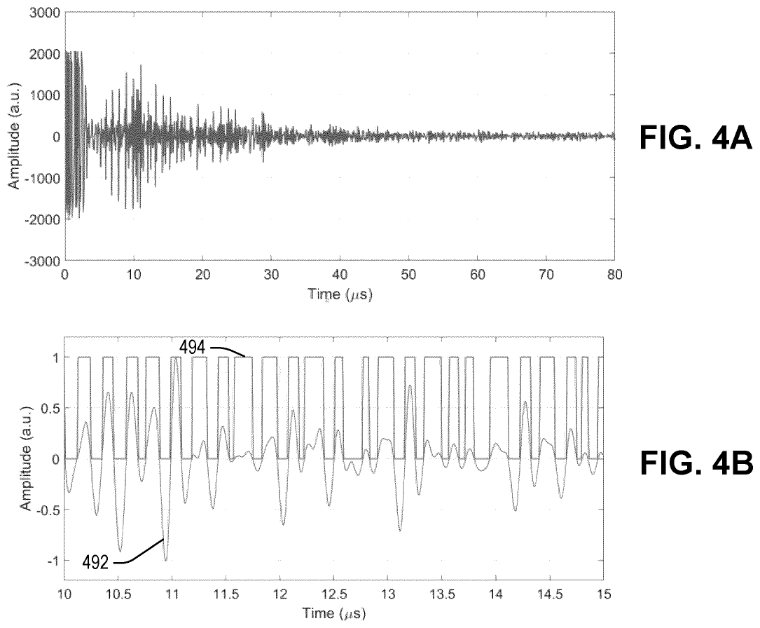

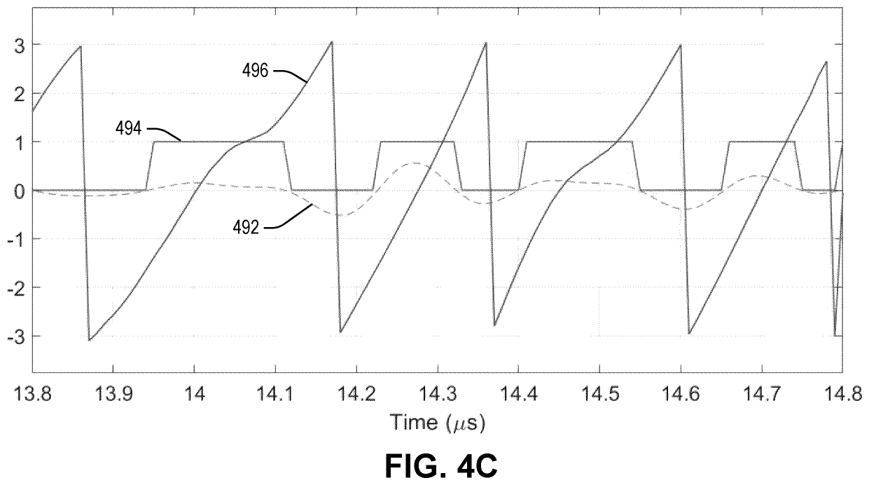

FIG. 4C illustrates generally an illustrative example of a portion of the normalized time-series 492 of FIG. 4B, a corresponding binarized representation 494 of the normalized time-series of FIG. 4B, and a corresponding instantaneous phase signal 496. The present inventors have recognized, among other things, that the instantaneous phase signal 496 exhibits a roughly piece-wise linear behavior during respective “pseudo” periods, where the periods are defined by roughly linear phase transitions between values of −π radians and +π radians. Such behavior exists in part because pulse echo signals are relatively narrowband signals with excursions around a center frequency. This piece-wise behavior facilitates use of the first or second phase construction techniques as discussed below. The use of the word “construction” can refer to “reconstruction” or “recovery” of phase data from a compressed representation of a time-domain instantaneous phase signal. Constructed representations of the time-domain instantaneous phase signals can then be used for summed A-scan construction, or TFM imaging, using summation of the time-domain phase signals. For example, time-domain representations of reconstructed instantaneous phase signals can be aggregated (e.g., coherently summed) comprising aggregating phase data from multiple quantized echo signals to generate at least one of an A-scan time series, a pixel value corresponding to a specified spatial location of the target, or a voxel value corresponding to the specified spatial location of a target such as test specimen.

FIG. 5A, FIG. 5B, and FIG. 5C collectively illustrate generally a first technique that can be used to construct a representation of an instantaneous phase signal (as shown in FIG. 5C) from a binarized representation of an acquired time-series (as shown in FIG. 5A), using data indicative of transitions (e.g., rising edges) in the binarized time-series (as shown in FIG. 5B). In the first technique, a binarized representation y_{B}(t) of FIG. 5A can be processed, such as to detect temporal locations of rising edge transitions as shown in the Dirac distribution d₁(t) in the simulation of FIG. 5B. Generally, an instantaneous phase can be modeled as a piece-wise linear approximation having phase that varies by 2π radians per pseudo-period between time indices defining adjacent rising edges in y_{B}(t). In practical application, edges in y_{B}(t) could be detected using a threshold comparator or digital signal processing of a digital representation of the binarized signal y_{B}(t) such as using a finite difference technique to estimate a derivative of y_{B}(t). The phase in FIG. 5C can be generated using the edge data from FIG. 5B and can model or otherwise represent an estimate of an “in-phase” component of the instantaneous phase of an analytic representation of the acquired pulse signal. For example, the phase estimate \hat{ϕ}₁(t) can be established to vary linearly (e.g., defining a slope) from a value of −π/2 radians at time tₙ₋₁, corresponding to a first rising edge transition in FIG. 5A, to a value of +3π/2 radiations at time tₙ, corresponding to a second, adjacent rising edge transition in FIG. 5A, defining a segment in a piece-wise approximation. The phase estimate \hat{ϕ}₁(t) can be represented analytically for all pairs of adjacent rising edges, tₙ and tₙ₋₁ as:

$${\hat{ϕ}}_{1} ( t ) = 2 π \cdot ( \frac{t - {t}_{n - 1}}{{t}_{n} - {t}_{n - 1}} ) - \frac{π}{2} mod 2 π$$

FIG. 5D illustrates generally a comparison between a representation of an instantaneous phase 552, \hat{ϕ}₁(t), as constructed in FIG. 5C, as compared to the actual acquired instantaneous phase 550 prior to binarization as shown earlier in FIG. 4C. The recovered phase 552 reasonably tracks values of the instantaneous phase 550 and is therefore suitable for use in phase summation techniques such as summed A-scan construction or TFM imaging via phase summation. As noted elsewhere herein, temporal locations of edge transitions as shown in FIG. 5B can be used to encode the phase information in a highly compressed form for transmission, storage, or downstream processing, as compared to transferring, storing, or manipulating a full time series record corresponding to the pulse echo time-domain signal of FIG. 5A or the instantaneous phase 550 shown in FIG. 5D. As mentioned elsewhere, summed A-scan or TFM imaging techniques generally involve use of many such pulse echo time series records, so bandwidth or data volume savings have a multiplicative effect as transducer count or aperture count increases.

FIG. 6A, FIG. 6B, and FIG. 6C collectively illustrate generally a second technique that can be used to construct a representation of an instantaneous phase signal (as shown in FIG. 6C) from a binarized representation of an acquired time-series (as shown in FIG. 6A), using data indicative of transitions (e.g., edges) in the binarized time-series (as shown in FIG. 6B). In a manner similar to the first technique, a reconstructed representation of the instantaneous phase signal varies over a range of 2π radians between −π/2 radians to +3π/2 radians over a period defined as a duration between adjacent rising edge transitions in the binarized representation y_{B}(t) of an acquired pulse echo signal. By contrast with the first technique discussed above, in the second technique, a piece-wise linear approximation of the phase as shown in FIG. 6C is constructed by dividing respective periods between adjacent rising edge transitions into two sub-periods defining different segments (e.g., segments that can have different slopes).

For example, as shown illustratively in FIG. 6A, a rising edge transition in the binarized signal is detected as shown in FIG. 6B at time t₂ₙ₋₁, and triggers a reset of the reconstructed instantaneous phase, \hat{ϕ}₂(t), in FIG. 6C to a value of −π/2 radians. A next adjacent falling edge transition in the binarized representation in FIG. 6A is detected as shown in FIG. 6B at time t₂ₙ, and the instantaneous phase \hat{ϕ}₂(t) in FIG. 6C is established by varying the phase linearly (e.g., defining a slope) from a value of −π/2 radians at t₂ₙ₋₁ to a value of +π/2 at t₂ₙ, defining a first sub-period. A duration between the falling edge transition and a next adjacent rising edge transition at time t₂ₙ₊₁ defines a linear transition between a phase value of π/2 at t₂ₙ and a phase value of +3π/2 at t₂ₙ₊₁ to define a second sub-period where the first and second sub-periods form a full pseudo-period. As in the examples of FIG. 5B, the representation in FIG. 6B can be a Dirac distribution d₂(t) representative of instants where rising or falling edge transitions occur in the binarized representation y_{B}(t) of FIG. 6A. The waveforms shown in FIG. 6B and FIG. 6C are simulated, and the reconstructed instantaneous phase, \hat{ϕ}₂(t), can be represented analytically as follows (e.g., for each group of rising-to-falling-to-next-rising edges):

$${\hat{ϕ}}_{2} ( t ) = \{ \begin{matrix}{o}_{a} ( t ) & for {t}_{2 n - 1} < t < {t}_{2 n} , \\ {o}_{b} ( t ) & for {t}_{2 n} < t < {t}_{2 n - 1}\end{matrix} .$$

### Where:

$${o}_{a} ( t ) = π \cdot ( \frac{t - {t}_{2 n - 1}}{{t}_{2 n} - {t}_{2 n - 1}} ) - \frac{π}{2} mod 2 π \\ and \\ {o}_{b} ( t ) = π \cdot ( \frac{t - {t}_{2 n}}{{t}_{2 n - 1} - {t}_{2 n}} ) - \frac{π}{2} mod 2 π .$$

FIG. 6D illustrates generally a comparison between a representation of an instantaneous phase 552, \hat{ϕ}₁(t), as constructed in FIG. 5C using the first technique, as compared to the actual acquired instantaneous phase prior to binarization 550 as shown earlier in FIG. 4C, along with another representation of the instantaneous phase 554, \hat{ϕ}₂(t), constructed as in FIG. 5C using the second technique. Both the recovered phase 552 and 554 reasonably track values of the instantaneous phase 550, with the second technique used to provide the phase 554 resulting in a better approximation of the instantaneous phase 550 prior to binarization, at the cost of slightly higher reconstruction complexity.

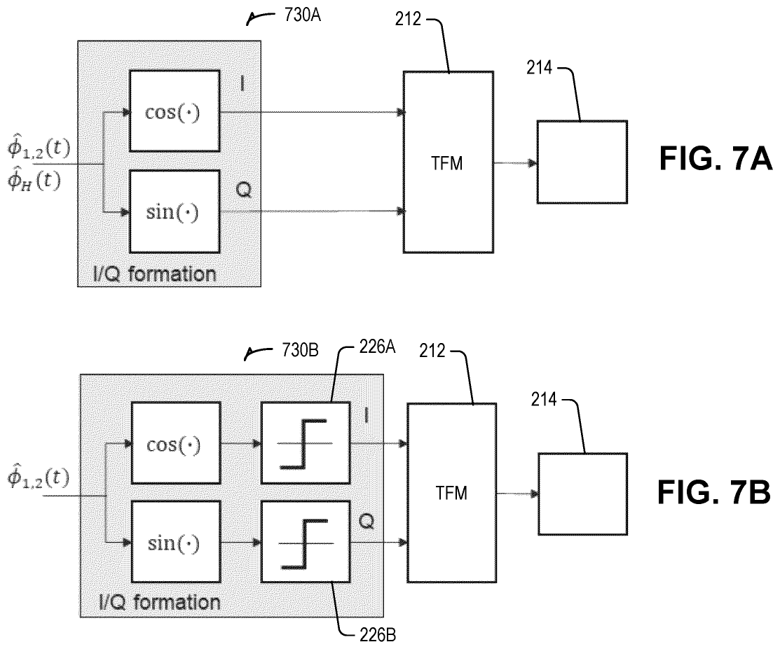

FIG. 7A illustrates generally an example comprising a portion of a receive signal chain 700A that can be used to provide in-phase and quadrature signals from a phase signal, such as can be used for a phase-summation TFM imaging technique. As mentioned above, certain imaging or processing techniques can include use of in-phase and quadrature representations of acquired time-domain pulse echo imaging data. In the phase-based approaches described herein, in-phase, “I” (y_{I}(t)) and quadrature, “Q” (y_{Q}(t)) signals can be generated from a representation of an instantaneous phase, such as a phase signal provided by a receiver architecture comprising \hat{ϕ}_{H}(t) (a Hilbert transform applied to the acquired A-scan time-series data y(t) to obtain the instantaneous phase \hat{ϕ}_{H}(t) corresponding to each acquired A-scan time-series), or reconstructed phase signals corresponding to the first or second techniques described above, \hat{ϕ}₁(t) or \hat{ϕ}₂(t). Resulting in-phase and quadrature signals (e.g., time series representations in the digital domain) can be provided for TFM imaging at 212 and further processing such as gamma correction or filtering at 214. The present inventors have recognized that the binarization approach for signal acquisition may be applied for phase-based imaging, such as shown in FIG. 7B, which illustrates generally another example of at least a portion of a receive signal chain 600B. In FIG. 7B, in-phase and quadrature representations of reconstructed phase signals, such as \hat{ϕ}₁(t) or \hat{ϕ}₂(t) can be quantized (e.g., binarized) using comparators 226A and 226B, and the resulting “square” representations can be provided for phase-summation imaging using a TFM approach in a manner similar to FIG. 7A. In yet another example, phase estimates provided using a Hilbert transform could also be provided as an input to the I/Q formation block shown in FIG. 7B. An analytical representation of the binarized or “square” in-phase and quadrature signal is:

y_{I}_{_{B}}(t)=sign[y_{I}(t)].

and

y_{Q}_{_{B}}(t)=sign[y_{Q}(t)].

In yet another approach, quantized (e.g., binarized representations) of the in-phase and quadrature signals could be established using a phase values from a unit-circle representation, such as assigned using a look-up table or similar technique. Such a technique can take the place of the sine and cosine functions in either FIG. 7A or FIG. 7B, as illustrative examples. For example, values of y_{I}i(t) and y_{Q}(t) could be assigned as follows based on a range of phase values in the input instantaneous phase signal \hat{ϕ}(t):

TABLE 1
Binarized In-phase and Quadrature Signal Values for
Respective Phase Ranges in \hat{ϕ} (t).

| Phase | //I_{B} (t) | //Q_{B} (t) |
|---|---|---|
| $0 \leq o ( t ) < - \frac{π}{2}$ | +1 | +1 |
| $+ \frac{π}{2} \leq o ( t ) < - π$ | −1 | +1 |
| $- π \leq o ( t ) < + 3 \frac{π}{2}$ | −1 | −1 |
| $+ 3 \frac{π}{2} \leq o ( t ) < 2 π$ | +1 | −1 |

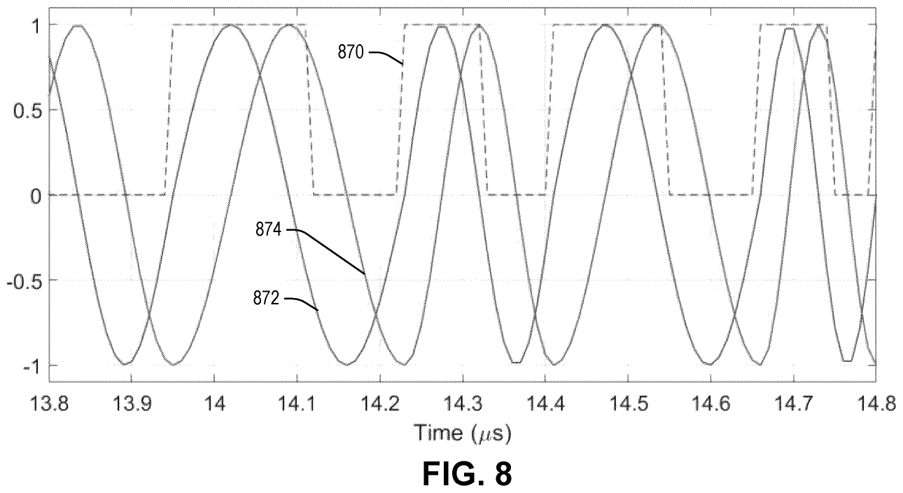

FIG. 8 illustrates generally an illustrative example of time-domain in-phase 872 and quadrature 874 signals, such as can be provided using the signal chain shown in FIG. 7A, along with a corresponding binarized representation 870 of an acquired time-series, to show the pi-radian phase relationship between the in-phase and quadrature signals, along with the relative phase versus edge transitions in the binarized representation 870 defining periods of the respective in-phase 872 and quadrature 874 signals.

The phase-summation approach described thus far herein can be used to support various analysis or imaging techniques. For example, summed A-scan generation can be performed, such as by summing time-domain phase representations acquired from multiple transducers or multiple transducer apertures, such as acquired using a PAUT approach.

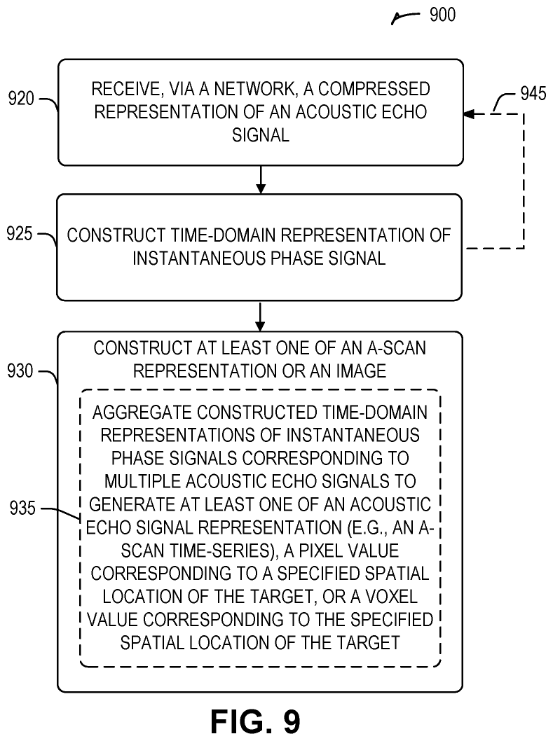

FIG. 9 illustrates generally a technique 900, such as a method for facilitating processing of acoustic echo signals, the technique comprising receiving a compressed representation of an acoustic echo signal and constructing a time-domain representation of an instantaneous phase signal, such as for use constructing a summed A-scan representation or an image, as illustrative examples. In particular, at 920, a compressed representation of an acoustic echo signal can be received. The compressed representation can include one or more of the examples shown in schemes (1), (2), (3), or (4) as discussed above in relation to FIG. 3C, FIG. 3D, FIG. 3E, or FIG. 3F, for example. As an illustrative examples, the compressed representation can include a quantized representation, such as a 1-bit quantized (e.g., binarized) representation of the acoustic echo signals, or data indicative of locations of one or more of rising or falling edges in such as a representation, or other data to facilitate an estimation of a time-domain representation of an instantaneous phase signal. For example, received compressed representation would generally provide data indicative of changes in phase values of the acoustic echo signal. At 925, the compressed representation can be used to construct a time-domain representation of an instantaneous phase signal, and at 930, at least one of an A-scan representation or an image can be constructed (e.g., using a TFM imaging approach employing a phase-summation technique). The receiving of multiple compressed representations of an acoustic echo signals and construction of corresponding time-domain representations of instantaneous phase signals can be performed on multiple acoustic echo signals as shown at 945 to facilitate A-scan construction or imaging (for either a single imaging frame or in support of multi-frame imaging). For example, at 935, time-domain representations of instantaneous phase signals corresponding to multiple acoustic echo signals can be aggregated to generate at least one of an A-scan time series, a pixel value corresponding to a specified spatial location, or a voxel value corresponding to a specified spatial location of a target (e.g., an object under inspection).

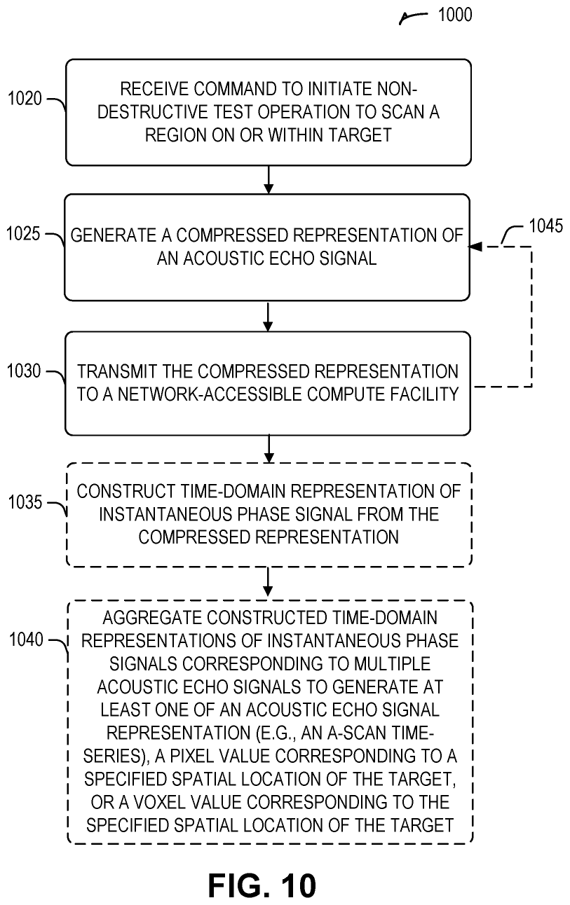

FIG. 10 illustrates generally a technique 1000, such as a method for operating an acoustic inspection system, comprising receiving a command to initiate a non-destructive test operation and to generate a compressed representation of an acoustic echo signal. As an illustration, in the technique 1000, at 1020 a command is received to initiate a non-destructive test operation to scan a region on or within a target. At 1025, a compressed representation of an acoustic echo signal is generated, such as where the acoustic echo signal is obtained pursuant to the non-destructive test operation commanded at 1020. At 1030, the compressed representation is transmitted to a network-accessible compute facility, either directly from an acoustic probe assembly, or using an intermediary device. At 1045, multiple such acoustic echo signals can be compressed and transmitted. At 1035, a time-domain representation of an instantaneous phase signal can be constructed form the compressed representation as shown and described in other examples herein. At 1040, the constructed time-domain representations can be aggregated to generate at least one of an A-scan time series, a pixel value corresponding to a specified spatial location of the target, or a voxel value corresponding to the specified spatial location of the target.

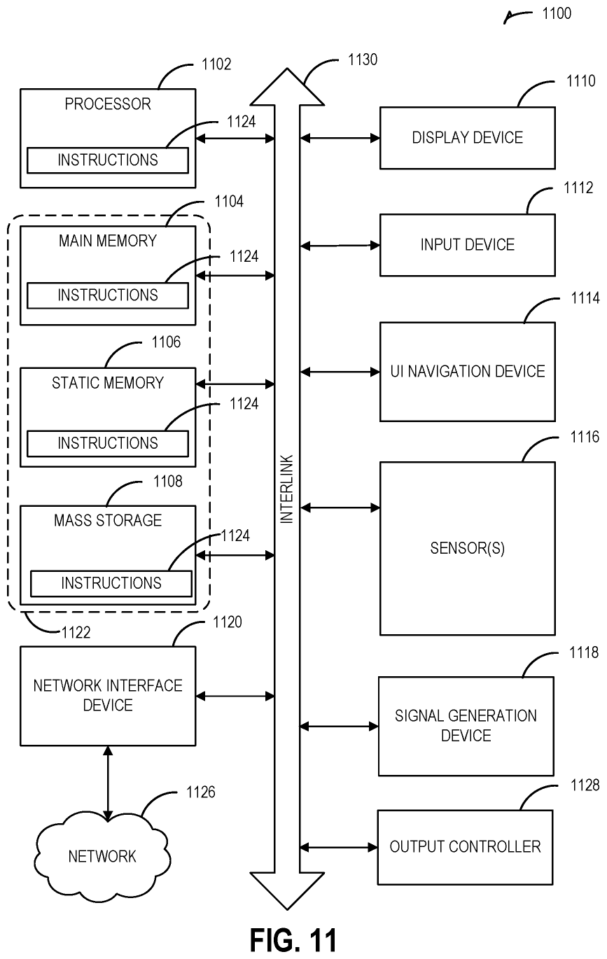

FIG. 11 illustrates a block diagram of an example comprising a machine 1100 upon which any one or more of the techniques (e.g., methodologies) discussed herein may be performed. In various examples, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. The machine 1100 may be a personal computer (PC), a tablet device, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware comprising the circuitry may include variably connected physical components (e.g., execution units, transistors, simple circuits, etc.) including a computer readable medium physically modified (e.g., magnetically, electrically, such as via a change in physical state or transformation of another physical characteristic, etc.) to encode instructions of the specific operation. In connecting the physical components, the underlying electrical properties of a hardware constituent may be changed, for example, from an insulating characteristic to a conductive characteristic or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 1100 may include a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1130. The machine 1100 may further include a display unit 1110, an alphanumeric input device 1112 (e.g., a keyboard), and a user interface (UI) navigation device 1114 (e.g., a mouse). In an example, the display unit 1110, input device 1112 and UI navigation device 1114 may be a touch screen display. The machine 1100 may additionally include a storage device (e.g., drive unit) 1108, a signal generation device 1118 (e.g., a speaker), a network interface device 1120, and one or more sensors 1116, such as a global positioning system (GPS) sensor, compass, accelerometer, or other sensor. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1108 may include a machine-readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within static memory 1106, or within the hardware processor 1102 during execution thereof by the machine 1100. In an example, one or any combination of the hardware processor 1102, the main memory 1104, the static memory 1106, or the storage device 1108 may constitute machine-readable media.

While the machine-readable medium 1122 is illustrated as a single medium, the term “machine-readable medium” may include a single medium or multiple media (e.g., a centralized or distributed database, and/or associated caches and servers) configured to store the one or more instructions 1124.

The term “machine-readable medium” may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Non-limiting machine-readable medium examples may include solid-state memories, and optical and magnetic media. Accordingly, machine-readable media are not transitory propagating signals. Specific examples of massed machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic or other phase-change or state-change memory circuits; magnetic disks, such as internal hard disks and removable disks; magneto-optical disks; and CD-ROM and DVD-ROM disks.

The instructions 1124 may further be transmitted or received over a communications network 1126 using a transmission medium via the network interface device 1120 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks such as conforming to one or more standards such as a 4G standard or Long Term Evolution (LTE)), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others). In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1100, and includes digital or analog communications signals or other intangible medium to facilitate communication of such software.

### Various Notes

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method, comprising:
receiving, via a network, a compressed representation of an acoustic echo signal acquired by a non-destructive test (NDT) probe assembly; and
using the compressed representation, constructing a time-domain representation of an instantaneous phase signal from the compressed representation;
wherein the compressed representation includes data indicative of changes in phase values of the acoustic echo signal; and
wherein the instantaneous phase signal is used in constructing at least one of an uncompressed acoustic echo signal representation or an image.

2. The method of claim 1, wherein amplitude values of sampled acoustic echo signals are suppressed in the compressed representation.

3. The method of claim 1, comprising:
receiving the acoustic echo signal from a transducer included as a portion of the non-destructive test (NDT) probe assembly;
forming a discrete-time representation of the acoustic echo signal;
encoding the discrete-time representation for transmission; and
wirelessly transmitting the encoded representation.

4. The method of claim 3, wherein establishing the compressed representation comprises binarizing the acoustic echo signal and establishing data indicative of time indices of edge transitions in quantized representations of the received acoustic echo signal; and
wherein an encoded representation includes the compressed representation.

5. The method of claim 1, wherein constructing the time-domain representation of the instantaneous phase signal from the compressed representation includes establishing a piece-wise construction.

6. The method of claim 5, wherein a slope of a segment in the piece-wise construction is established at least in part by determining a duration between adjacent edge transitions of a quantized representation of the received acoustic echo signal.

7. The method of claim 1, wherein the compressed representation is received by a network-accessible compute facility, including receiving the compressed representation via an intermediary device between the NDT probe assembly and the network-accessible compute facility.

8. The method of claim 7, wherein the intermediary device comprises at least one of a tablet device, a mobile device, a portable computer, a desktop computer, or a local wireless gateway.

9. The method of claim 7, wherein the intermediary device comprises:
a first wireless transceiver circuit to communicate with a wireless transceiver circuit of the NDT probe assembly using a first wireless communication scheme; and
a second wireless transceiver circuit to communicate with the network-accessible compute facility using a different second wireless communication scheme.

10. The method of claim 1, comprising aggregating constructed time-domain representations of instantaneous phase signals corresponding to multiple acoustic echo signals to generate at least one of an A-scan time series, a pixel value corresponding to a specified spatial location of a target, or a voxel value corresponding to the specified spatial location of the target.

11. The method of claim 10, wherein the aggregating is performed using a network-accessible compute facility, and at least one the A-scan time series, a pixel value corresponding to the specified spatial location of the target, or the voxel value are transmitted for presentation on a device separate from the network-accessible compute facility.

12. A system for performing non-destructive testing, the system comprising:
A non-destructive test (NDT) probe assembly comprising:
at least one transducer;
an analog receiver circuit electrically coupled to the at least one transducer; and
a wireless transceiver circuit communicatively coupled to the analog receiver circuit, the wireless transceiver circuit comprising an encoder and a transmitter, the transmitter configured to transmit an encoded representation of an echo signal received by the analog receiver circuit from the at least one transducer; and
a network-accessible compute facility separate from the probe assembly, the compute facility comprising at least one processor circuit, the at least one processor circuit coupled to a memory circuit comprising instructions that, when executed by the at least one processor circuit cause the compute system to receive the encoded representation of the echo signal and to construct a time-domain representation of an instantaneous phase signal using the encoded representation.

13. The system of claim 12, further comprising an intermediary device comprising:
a first wireless transceiver circuit to communicate with the wireless transceiver circuit of the probe assembly using a first wireless communication scheme; and
a second wireless transceiver circuit to communicate with the compute facility using a different second wireless communication scheme.

14. The system of claim 12, wherein the encoded representation of the echo signal comprises a compressed representation of a time-domain echo signal established from a quantized representation of the time-domain echo signal.

15. The system of claim 14, wherein amplitude values of the time-domain echo signal are suppressed in the compressed representation.

16. The system of claim 14, wherein the compressed representation of the time-domain echo signal received by the compute facility comprises data indicative of time indices of edge transitions in the quantized representation of the time-domain echo signal.

17. The system of claim 14, wherein the instructions comprise instructions to construct the time-domain representation of the instantaneous phase signal from the compressed representation including establishing a piece-wise construction.

18. The system of claim 12, wherein the instructions comprise instructions to aggregate constructed time-domain representations of instantaneous phase signals corresponding to multiple acoustic echo signals to generate at least one of an A-scan time series, a pixel value corresponding to a specified spatial location of a target, or a voxel value corresponding to the specified spatial location of the target.

19. The system of claim 18, comprising a display device configured to receive at least one of a generated A-scan time series, a pixel value corresponding to the specified spatial location of the target, or a voxel value corresponding to the specified spatial location of the target.

20. The system of claim 12, comprising an optical imaging device included as a portion of the probe assembly.

21. A method, comprising:
receiving, via a network, a command to initiate a non-destructive test operation to scan a region on or within a target;
in response, generating a compressed representation of an acoustic echo signal acquired by a non-destructive test (NDT) probe assembly; and
transmitting the compressed representation to a network-accessible compute facility for construction of a time-domain representation of an instantaneous phase signal from the compressed representation;
wherein the compressed representation includes data indicative of changes in phase values of the acoustic echo signal; and
wherein the instantaneous phase signal is used in constructing at least one of an uncompressed acoustic echo signal representation or an image.

22. The method of claim 21, comprising receiving at least one of a generated A-scan time series, a pixel value corresponding to a specified spatial location of the target, or a voxel value corresponding to a specified spatial location of the target, the at least one of the generated A-scan time series, the pixel value corresponding to the specified spatial location of the target, or the voxel value corresponding to the specified spatial location of the target generated using the compressed representation.

23. The method of claim 22, where the generation of the at least one of the generated A-scan time series, the pixel value corresponding to the specified spatial location of the target, or the voxel value corresponding to the specified spatial location of the target is performed using a device separate from the NDT probe assembly.

24. The method of claim 21, wherein the non-destructive test (NDT) probe assembly does not require human supervision for initiation of the non-destructive test operation or generation of the compressed representation of the acoustic echo signal.

25. The method of claim 21, wherein the receiving, via the network, the command to initiate the non-destructive test operation includes wirelessly receiving the command.

26. The method of claim 21, comprising transmitting an optical image of a region nearby the probe assembly, acquired by the probe assembly.
